(19) United States
(12) Patent Application Publication
(10) Pub. No.: US 2022/0266364 A1
(43) Pub. Date: Aug. 25, 2022

(54) TOOL AND METHOD FOR MACHINING A WORKPIECE

(71) Applicant: Hartmetall-Werkzeugfabrik Paul Horn GmbH, Tuebingen (DE)

(72) Inventor: Johannes HOSS, Ofterdingen (DE)

(21) Appl. No.: 17/741,731

(22) Filed: May 11, 2022

Related U.S. Application Data
(63) Continuation of application No. PCT/EP2020/079368, filed on Oct. 19, 2020.

(30) Foreign Application Priority Data
Dec. 20, 2019 (DE) 10 2019 135 435.8

(51) Int. Cl. B23F 5/16

(52) U.S. Cl. CPC B23F 5/163

(57) ABSTRACT

A power skiving tool comprising a shank that extends along a longitudinal axis of the tool, and a cutting head that is arranged at an end face of the shank. The cutting head comprises a plurality of circumferentially arranged teeth, wherein, when viewed in a cross-section orthogonal to the longitudinal axis, each of the teeth comprises a convexly rounded contour, which at a first end transitions either directly or via a first concave transition contour into the convexly rounded contour of a first adjacent tooth of the plurality of teeth and at a second end opposite the first end transitions either directly or via a second concave transition contour into the convexly rounded contour of a second adjacent tooth of the plurality of teeth. A width of each tooth of the plurality of teeth, measured in the cross-section as a distance between the first end and the second end, is greater than a height of the respective tooth, measured in the cross-section orthogonal to the width and centrally between the first end and the second end.

### CROSS-REFERENCE TO RELATED APPLICATIONS

This application is a continuation of international patent application PCT/EP2020/079368, filed on Oct. 19, 2020 designating the U.S., which international patent application has been published in German language and claims priority from German patent application DE 10 2019 135 435.8, filed on Dec. 20, 2019. The entire contents of these priority applications are incorporated herein by reference.

### BACKGROUND

The present disclosure relates to a tool and a method for machining a workpiece. The herein presented tool and method are particularly suitable for producing an outer contour on a workpiece, which outer contour, in the cross-sectional profile of the workpiece, corresponds substantially to a regular convex polygon.

A regular convex polygon is a polygon whose edges touch or intersect only at the vertices, wherein all interior angles are less than 180°, and which is both equilateral and equiangular. Examples of such regular convex polygons are equilateral triangles, squares, equilateral pentagons, equilateral hexagons, etc.

A typical application of such a cross-sectional profile is the production of a hexagonal bar on a workpiece. For example, the workpiece may be a screw or bolt with a hexagonal bar. In this typical application, the workpiece thus otherwise has a round cross-section and comprises flat surfaces on the circumference of the otherwise round or cylindrical workpiece only in the area where the hexagonal or polygonal bar is located.

Typically, such polygonal shapes are produced on otherwise round workpieces by means of milling. Classical turning machining is not possible due to the flat surfaces to be produced on the workpiece.

However, the ever-increasing pressure to reduce costs in industry, especially in the production of series and mass-produced parts, as is the case with the bolts mentioned as an example, is forcing a permanent review of run-in processes, which also includes the milling of several flat surfaces on the lateral surface of round steel workpieces. Even small time savings in the production of a part multiply into a considerable potential for cost savings and machine capacity gains in larger series.

As an alternative to classical milling, the so-called polygon turning has therefore emerged as a process for the production of polygonal profiles (cross-sectional profiles corresponding to a regular convex polygon). Polygon turning opens up the previously mentioned savings potentials compared to classic milling.

Polygon turning enables the production of flat surfaces on an otherwise round lateral surface of the workpiece. This machining process is typically performed on a lathe, wherein not only the workpiece but also the tool is driven. The workpiece in the main spindle and the rotating tool in the turret of the machine run in a synchronous transmission ratio to each other. The number of surfaces produced on the workpiece depends on this transmission ratio between workpiece and tool as well as the number of cutting edges on the tool. In the prior art, for example, the tool rotates at twice the speed of the workpiece, and the number of cutting edges multiplied by a factor of 2 gives the number of polygonal faces produced. Thus, in this case, a hexagonal profile can be produced by means of polygon turning with a tool that comprises three cutting blades regularly distributed around the circumference.

Due to the fact that polygon turning is typically performed on a lathe, this machining process is often also referred to as polygon turning. Further information on this type of machining process can be found, for example, in DE 20 2015 002 876 U1.

Although polygon turning has established itself as a cost-effective and technically sophisticated alternative to conventional milling for the production of polygonal profiles, disadvantages have nevertheless emerged due to the process. As can be easily understood, the process does not produce exactly flat surfaces on the polygonal profile. Instead, the individual surfaces of the polygonal profile are slightly convex. In addition, it is not possible to achieve the same surface quality as is the case, for example, with conventional milling. However, as long as higher precision is not required and the focus is on cost savings, polygon turning for the production of polygonal profiles on workpieces is still a serious alternative.

Nevertheless, there is a need to produce polygonal profiles in a comparatively cost-effective way by alternative manufacturing processes that do not have the disadvantage of occurring crowned surfaces.

### SUMMARY

It is an object to provide a tool as well as a method which enables the production of a polygonal profile on a workpiece in a cost-effective and process-reliable manner and which enables better machining results on the workpiece compared to the already known polygon turning.

In accordance with a first aspect, a power skiving tool is provided, comprising a shank that extends along a longitudinal axis of the tool and a cutting head arranged at an end face of the shank, wherein the cutting head comprises a plurality of circumferentially arranged teeth, wherein, when viewed in a cross-section orthogonal to the longitudinal axis, each of the teeth comprises a convexly rounded contour, which at a first end transitions either directly or via a first concave transition contour arranged therebetween into the convexly rounded contour of a first adjacent tooth of the plurality of teeth, and at a second end opposite the first end transitions either directly or via a second concave transition contour arranged therebetween into the convexly rounded contour of a second adjacent tooth of the plurality of teeth, and wherein a width of each tooth of the plurality of teeth measured in the cross-section as a distance between the first end and the second end is greater than a height of the respective tooth measured in the cross-section orthogonal to the width and centrally between the first end and the second end.

According to a second aspect, a method for machining a workpiece is provided, which comprises the following steps:
providing a power skiving tool and the workpiece to be machined;
producing an outer contour on the workpiece by means of the power skiving tool during power skiving machining, wherein the outer contour to be produced corresponds substantially to a regular convex polygon in a cross-sectional profile of the workpiece, and wherein the power skiving tool and the workpiece are rotated with opposite directions of rotation to one another during the power skiving machining, wherein an axis of rotation of the power skiving tool is aligned at a defined axis cross angle with respect to an axis of rotation of the workpiece, and the power skiving tool and/or the workpiece are simultaneously moved translationally to generate a feed motion.

Instead of the previously known manufacturing processes such as milling and polygon turning, power skiving machining is used in the present case to produce the polygonal profile using an appropriate power skiving tool. Power skiving machining itself has been known for quite some time. However, the idea of using power skiving to produce a polygonal profile is new.

Power skiving is typically used for the production of gear teeth, be it internal gear teeth or external gear teeth. A typical field of application is the manufacture of gear wheels.

Power skiving itself has been known for more than 100 years. The first patent application in this field, number DE 243514, dates back to 1910. In the years that followed, power skiving did not attract much attention for a long time. In the past decade, however, this very old manufacturing process for machining a workpiece has been taken up again and is now widely used in the production of various gear teeth. A comparatively recent patent application on this subject is, for example, WO 2012/152659 A1.

Power skiving is typically used as an alternative to hobbing or gear shaping in the manufacture of gear wheels. It enables a significant reduction in machining time compared to hobbing and gear shaping. In addition, a very high machining quality can be achieved. Power skiving therefore enables very productive and at the same time highly precise manufacture of gear teeth.

In power skiving, the workpiece and the tool are driven with a coordinated (synchronized) speed ratio. When producing external gear teeth, the workpiece and the tool are driven in opposite directions of rotation. In the manufacture of internal gear teeth, on the other hand, the workpiece and the tool are driven in the same direction of rotation.

The tool is set at an angle relative to the workpiece at a predetermined angle, which is usually referred to as the axis cross angle. The axis cross angle designates the angle between the rotation axis of the power skiving tool and the rotation axis of the workpiece to be machined.

To generate a feed motion, the tool and/or the workpiece is also moved translationally. The resulting relative movement between the power skiving tool and the workpiece is therefore a type of screw movement, which has a rotary component (rotational component) and a feed component (translational component).

The workpiece is machined with the teeth arranged circumferentially on the cutting head of the power skiving tool. The crossed axis arrangement creates a relative speed between the tool and the workpiece. This relative motion is utilized as a cutting motion and has its main cutting direction along the tooth gap of the workpiece. It is therefore said that the chip is “peeled out” during machining. The size of the cutting speed depends on the size of the axis cross angle of the feed movement and on the speed of the machining spindles.

Using such a power skiving machining for the manufacture of gear wheels or other types of gear teeth has, as already mentioned, become established. However, it has now been discovered that such power skiving machining can also be used to produce polygonal profiles (cross-sectional profiles corresponding to a regular convex polygon). Although this was initially surprising, it has turned out to be extremely advantageous, since the typical advantages of power skiving can thus also be utilized in the manufacture of polygonal profiles.

In this way, polygonal profiles can be produced even faster than is the case with polygon turning. Furthermore, the machining conditions as well as the cutting forces are significantly better with power skiving than with polygon turning, since the workpiece is machined “peeling” rather than “hammering”. As a result, polygonal profiles with a significantly higher surface quality can be produced.

Furthermore, no crowned surfaces are produced as compared to polygon turning. Instead, almost completely flat surfaces can be produced on the workpiece. In addition, the angular transitions between the individual flat surfaces of the polygonal profile can also be produced much more precisely by means of power skiving than by means of polygon turning. All in all, this results in an extremely advantageous type of production that was by no means foreseeable.

One insight of the inventors that enabled the production of polygonal profiles by means of power skiving was the idea of giving the teeth on the power skiving tool a special shape. Unlike power skiving tools used for the typical manufacture of gear teeth, the herein presented power skiving tool is equipped with convexly rounded teeth that are significantly flatter or less curved.

Preferably, the individual teeth are continuously curved. In other words, the teeth have no kink or corner when viewed in a cross-section orthogonal to the longitudinal axis of the tool. In the cross-section, each tooth has thus a continuous and steady tangent slope.

A “convexly rounded” contour is understood here to be any type of outwardly curved contour which is rounded, i.e. without clear corners and edges. In the described cross-section, however, this contour is not necessarily conformed to a circular shape or exactly circular, but can also be elliptical or oval or have some other rounded free form. Preferably, a convexly rounded freeform is actually used as the contour in the cross-section orthogonal to the longitudinal axis.

Between these teeth, which have a convexly rounded contour, either a concave transition contour can be provided in each case or a direct transition can be realized between the individual teeth. If a concave transition structure is provided between the individual teeth, it is preferably small in comparison to the teeth. The smaller this transition structure is, the better the corners of the polygonal profile can be created on the workpiece. The concave transition structure can also be quite angular and, unlike the convexly rounded contour of the teeth, does not have to be rounded.

The individual teeth are preferably significantly wider than they are high. The width b in this case is measured as the distance between the first end and the second end of each tooth. The height h is measured as a height of the respective tooth measured in the same cross-section orthogonal to the width and centrally between the first end and the second end. Preferably, the height h is the distance from a point on the contour of the tooth equidistant from the first and second ends to a connecting line between the first and second ends. The length of the latter connecting line is equal to the width of the tooth.

Due to this very flat and slightly curved configuration of the teeth of the power skiving tool, it is also possible to produce almost completely flat surfaces on the workpiece by means of power skiving.

The corner machining of the polygonal profiles is mainly done by the transitions between the individual teeth.

By appropriately coordinating the speed ratio of the speeds at which the workpiece or the tool are rotated, different regular polygonal cross sections can be produced on the workpiece. Preferably, the power skiving tool is rotated at a first speed and the workpiece is rotated at a second speed, the second speed being an integer multiple of the first speed. Thus, the workpiece is typically rotated faster than the tool. However, this in itself, as well as the other parameters of the power skiving machining, are consistent with conventional power skiving machining used to produce gear teeth.

According to a refinement, the width of each tooth of the plurality of teeth is more than twice the height of the respective tooth. Particularly preferably, the width of each tooth is more than three times the height of the respective tooth.

The teeth are thus extremely flat compared to the teeth of a classic power skiving tool. This is particularly advantageous for ensuring the most exact possible planarity of the flat surfaces to be produced on a polygonal profile. It may even be provided that the ratio of width to height of each tooth is even greater than 5:1, 6:1 or 7:1.

A further feature of the described flat or slightly curved configuration of the individual teeth can be that a first tangent applied to the first end of the convexly rounded contour of each tooth in the cross section orthogonal to the longitudinal axis of the tool and a second tangent applied to the second end of the convexly rounded contour in the cross section intersect at an angle α, where 60°≤α≤140°. Preferably, even 80°≤α≤130° applies.

In contrast, teeth of conventional power skiving tools typically have two opposite side flanks that are aligned almost parallel or even exactly parallel to each other at the transition between the individual teeth, so that in this case the described tangents would either have no point of intersection at all or would enclose a significantly smaller angle.

According to a further refinement, the first and the second concave transition structure, i.e. the transition structure between the individual teeth of the power skiving tool, is a radius when viewed in cross-section orthogonal to the longitudinal axis. This radius, configured as a transition contour, also cuts during machining, as already mentioned, and thus machines the workpiece.

Furthermore, it is preferred that each tooth of the plurality of teeth has a shape identical to the other teeth of the plurality of teeth. Typically, in fact, the power skiving tool cuts along the entire circumference during power skiving, with each tooth being rolled over one of the flat surfaces to be machined during the production of a polygonal profile.

According to a further refinement, each of the plurality of teeth comprises a planar rake face at an end of the cutting head that is facing away from the shank, the rake face being inclined at an angle other than 90° with respect to the longitudinal axis.

Thus, the rake faces are typically located on an upper surface of the teeth; they form the face end of the cutting head, which faces away from the shank of the power skiving tool. Typically, the rake faces are designed as planar surfaces. With respect to the longitudinal axis of the power skiving tool, the rake faces are preferably inclined, i.e. not perpendicular to the longitudinal axis.

Depending on the configuration of the power skiving tool, the rake faces of all teeth can be arranged in a common conical face that is rotationally symmetrical to the longitudinal axis. Alternatively, a transition surface is arranged between the rake faces of each of two adjacent teeth, which transition surface is also arranged at the front end of the cutting head and is directly adjacent to the rake faces of the two adjacent teeth. The individual rake faces of the teeth then lie in different planes in each case. Individual stair-like steps are then formed between the individual teeth on the face end or between the rake faces. The latter occurs particularly because the rake faces of the teeth are typically produced with a grinding wheel. This typically results in a step between the rake face of one tooth and the rake face of an adjacent tooth, which looks like a kind of stair step. However, as already mentioned, the power skiving tool can also be configured in such a way that all rake faces are arranged in a common conical surface.

According to a refinement, the power skiving tool comprises a total of twenty-four teeth. Due to this relatively high number of teeth, the production of polygonal profiles is significantly faster than by means of classical milling and even faster than by means of polygon turning.

According to a further refinement, it is provided that each of the teeth comprises a circumferentially arranged flank oriented skew to the longitudinal axis. The flanks of the teeth thus preferably run non-parallel to the longitudinal axis.

According to a further refinement of the power skiving tool, the cutting head can be detachably attached to the shaft. In this case, the cutting head can be replaced as a whole when worn and replaced by a new one. Various interfaces can be considered as the interface between the cutting head and the shank. Preferably, the interface comprises a screw connection.

The cutting head or at least the teeth arranged thereon are preferably made of carbide, whereas the shank of the power skiving tool is typically made of steel. However, depending on the size of the power skiving tool, the entire tool may also be made of tungsten carbide. Similarly, it is possible to equip the cutting head of the generating tool with individual indexable inserts that form the teeth. Furthermore, carbide cutting edges that form the teeth can be brazed onto the replaceable head.

It is understood that the above features and those to be explained below can be used not only in the combination indicated in each case, but also in other combinations or on their own, without departing from the spirit and scope of the present disclosure.

### BRIEF DESCRIPTION OF THE DRAWINGS

FIG. 1 a perspective view of an embodiment of a power skiving tool;

FIG. 2 a side view of the power skiving tool shown in FIG. 1;

FIG. 3 a detailed view from FIG. 2;

FIG. 4 a top view from below of the power skiving tool shown in FIGS. 1 and 2;

FIG. 5 a detail from FIG. 4;

FIG. 6 the detail shown in FIG. 5 in a sectional view orthogonal to the longitudinal axis of the power skiving tool;

FIG. 7 a perspective view of the cutting head of the power skiving tool shown in FIG. 1;

FIG. 8 a detail from FIG. 7;

FIG. 9 a perspective view of the power skiving tool shown in FIG. 1 together with a workpiece to be machined; and

FIG. 10a-d several views illustrating a power skiving operation on a workpiece using the power skiving tool.

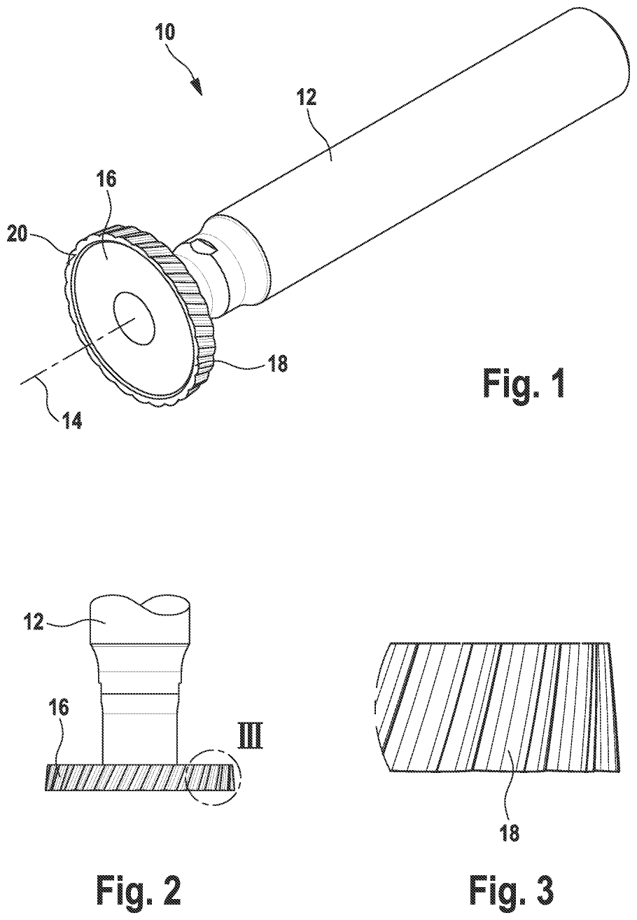

### DESCRIPTION OF PREFERRED EMBODIMENTS

FIG. 1 shows a perspective view of an embodiment of the power skiving tool. The power skiving tool is denoted therein in its entirety with the reference numeral 10.

The power skiving tool 10 comprises a shank 12 extending along a longitudinal axis 14. In the shown embodiment, the shank 12 is cylindrical. In principle, however, it can also have a different shape, for example a cuboid shape.

Furthermore, the power skiving tool 10 comprises a cutting head 16 which is arranged at a front end of the shaft. A plurality of teeth 18 are arranged on the cutting head 12, which teeth are distributed around the circumference of the cutting head 16.

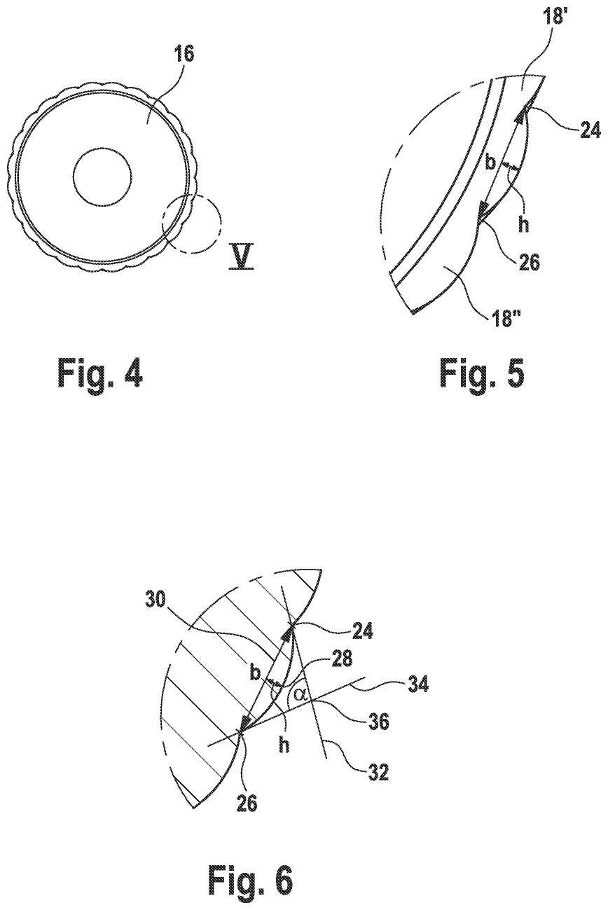

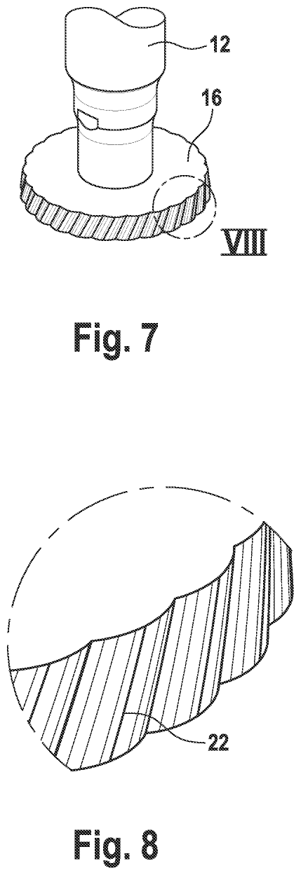

As can be seen in particular in FIGS. 4-6, the teeth 18 comprise a convexly rounded contour. More specifically, the teeth 18 comprise this convexly rounded contour in a cross-section orthogonal to longitudinal axis 14, as shown in FIG. 6.

Unlike the teeth of conventional power skiving tools, the teeth 18 of the power skiving tool 10 are neither angular nor pointed. They have a much rounder design, which means that they have no corners or sharp edges. A further feature of the power skiving tool 10 can be seen in the fact that the teeth 18 are designed to be significantly flatter or less strongly curved than is the case with conventional power skiving tools which are used to produce gear teeth.

The teeth 18 comprise a rake face 20 at a front end of the teeth 18 facing away from the shank 12. As can be seen in particular from FIG. 4, the rake faces 20 of all teeth 18 lie in a common plane in the power skiving tool 10 according to the herein shown embodiment. This plane is a conical plane which extends all around at a constant angle relative to the longitudinal axis 14. Alternatively, however, it is also possible for the rake faces 20 of the individual teeth to be arranged in different planes, in which case a kind of step is formed between the rake faces 20 of two adjacent teeth 18 in each case.

The power skiving tool 10 according to the herein shown embodiment comprises a total of twenty-four such teeth 18. These twenty-four teeth 18 are evenly distributed around the circumference of the cutting head 16 and project in a star shape from the circumference thereof. However, as can be seen from the figures, the teeth 18 do not project from the circumference of the cutting head 16 exactly in a radial direction (orthogonal to the longitudinal axis 14).

On the circumferential side, each of the teeth 18 comprise a flank 22 representing the radially outermost part of each tooth 18 and thus also the radially outermost part of the cutting head 16. These flanks 22 are oriented skew with respect to the longitudinal axis 14, which can be seen in particular in FIG. 3.

FIGS. 5 and 6 illustrate the low curvature and the flat configuration of the teeth 18 characteristic of the power skiving tool 10. In this regard, FIG. 6 shows a detail of the cutting head 16 in a cross-section oriented orthogonally to the longitudinal axis 14. Additionally to the convexly rounded contour of each tooth 18, it is further apparent from FIGS. 5 and 6 that the teeth 18 merge directly into one another according to the herein shown embodiment. That is, in other words, each tooth 18 in the cross-section shown in FIG. 6 merges directly into the convexly rounded contour of an adjacent tooth 18′ at its first end 24 and merges directly into the convexly rounded contour of its second adjacent tooth 18″ at its second end 26 opposite the first end 24.

Instead of a direct transition of the convexly rounded contours of the individual teeth 18 into one another, concave transition contours can also be provided between the individual teeth 18, but these are comparatively small in comparison to the convexly rounded contours formed by the teeth 18 in the shown cross section. For example, radii may be considered as concave transition contours between the individual teeth 18.

The flat or slightly curved configuration of the individual teeth can be characterized in particular by the following features: A width b of each tooth 18 measured in the cross-section shown in FIG. 6 as a distance between the first end 24 and the second end 26 is significantly greater than a height h of the respective tooth 18 measured in the cross-section orthogonal to the width b and centrally between the first end 24 and the second end 26. As indicated in FIG. 6, the height is measured as a distance from a point 28 on the contour of the tooth 18 to a connecting line 30 between the first and second ends 24, 26. The length of the connecting line 30 corresponds to the width b of the tooth 18. The point 28 is a point at the zenith of the tooth that has an equal distance from the first end 24 and the second end 26.

Preferably, there is a ratio between the width b and the height h of at least 2:1, preferably at least 3:1 or even at least 5:1.

A first tangent 32 applied to the first end 24 of the convexly rounded contour of tooth 18 in the cross-section shown in FIG. 6 and a second tangent 34 applied to the second end 26 of the convexly rounded contour of tooth 18 in the cross-section intersect at an angle α, which is preferably in the range of 60°≤α≤140°. As can be seen from FIG. 6, the angle α is an interior angle measured at the intersection of the two tangents 32, 34 within the imaginary triangle the three corners of which are the intersection 36 of the two tangents 32, 34, the first end 24 and the second end 26.

The individual teeth 18 preferably all have an identical shape corresponding to the previously mentioned shape. The teeth 18 are preferably made of carbide, while the shank 12 is preferably made of steel.

The power skiving tool 10 is particularly suitable for producing an outer contour which, in the cross-sectional profile of the workpiece, corresponds substantially to a regular convex polygon. The term “substantially”, which is associated with the term “regular convex polygon”, is intended to clarify at this point that the contour to be produced on the workpiece is a regularly polygonal cross-sectional profile in the overall view, which however does not necessarily correspond exactly to a regular polygon at the microscopic level or already in the detailed view due to manufacturing inaccuracies. For example, individual roundings may occur in the corners of the polygonal profile.

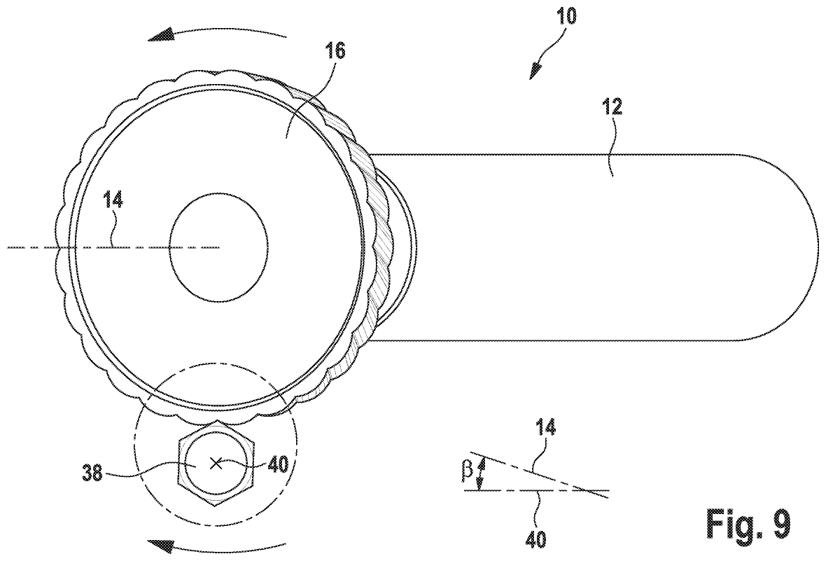

FIG. 9 illustrates in a very generally the way in which the power skiving tool 10 interacts with a workpiece 38. During power skiving machining, both the power skiving tool 10 and the workpiece 38 are rotated. However, the power skiving tool 10 and the workpiece 38 are rotated with contrary or opposite directions of rotation with respect to each other. In the example shown in FIG. 9, the workpiece 38 is rotated clockwise and the power skiving tool 10 is rotated counterclockwise.

The power skiving tool 10 is rotated about its longitudinal axis 14. The longitudinal axis of the workpiece 38 serves as the axis of rotation 40 of the workpiece 38. Although this is not clearly evident in FIG. 9, the two axes of rotation 14, 40 are not parallel, but are oriented transversely to each other at a so-called axis cross angle. This oblique arrangement of the rotational axes 14, 40 relative to each other is characteristic for power skiving. The crossed axis arrangement results in a relative speed between the power skiving tool 10 and the workpiece 38.

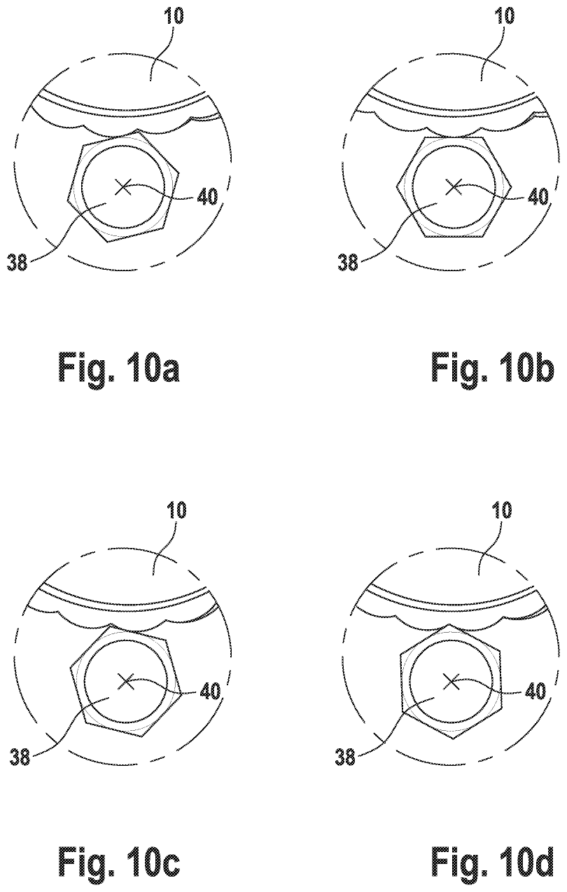

During the power skiving machining, the individual teeth 18 slide on the workpiece 38, lifting chips from the workpiece 38. This can be seen, for example, in the sequence of figures schematically indicated in FIGS. 10a-10d, which serves to illustrate the power skiving process.

In addition to the rotation of the workpiece 38 and the tool 10, the tool 10 and/or the workpiece 38 are also moved translationally during power skiving. In this way, a kind of screwing movement is created by which the chip lifted from the workpiece 38 is “peeled out”.

In the present case, an outer contour is produced on the workpiece 38 by means of the power skiving tool 10 in the mentioned manner, which outer contour corresponds to a regular hexagon when viewed in cross-section. Such an outer contour corresponds, for example, to the outer contour of a hexagon on a screw or bolt.

As can be seen in particular from the sequence of figures shown schematically in FIGS. 10a-10d, the flat surfaces of the hexagonal profile are produced with the aid of the teeth 18, which have the flat and comparatively slightly curved, convexly rounded contour described above. The corners of the hexagonal profile, on the other hand, are created with the aid of the transition contours between the teeth 18 or with the tooth spaces, resulting in more or less exact corners on the workpiece 38.

During the power skiving operation, the workpiece 38 is preferably rotated at a higher speed than the power skiving tool 10. For example, a speed ratio of 3:1 may be provided to produce the exemplary hexagonal profile on the workpiece 38. For example, the power skiving tool 10 may be rotated at a speed in the range of 3,000 rpm while the workpiece 38 is rotated at a speed in the range of 12,000 rpm. The axis cross angle R, shown only schematically in FIG. 9, can be 25°, for example. The cutting speed may be set to 100 m/min.

In this way, it is very easy, inexpensive and extremely fast to create an outer contour on a workpiece 38 which corresponds in cross-section to a regular convex polygon course.

What is claimed is:

1. A power skiving tool, comprising a shank that extends along a longitudinal axis of the tool, and a cutting head that is arranged at an end face of the shank, wherein the cutting head comprises a plurality of circumferentially arranged teeth, wherein, when viewed in a cross-section orthogonal to the longitudinal axis, each of the teeth comprises a convexly rounded contour, which at a first end transitions either directly or via a first concave transition contour into the convexly rounded contour of a first adjacent tooth of the plurality of teeth and at a second end opposite the first end transitions either directly or via a second concave transition contour into the convexly rounded contour of a second adjacent tooth of the plurality of teeth, and wherein a width of each tooth of the plurality of teeth, measured in the cross-section as a distance between the first end and the second end, is greater than a height of the respective tooth measured in the cross-section orthogonal to the width and centrally between the first end and the second end.

2. The power skiving tool according to claim 1, wherein the width of each tooth of the plurality of teeth is more than twice the height of the respective tooth.

3. The power skiving tool according to claim 1, wherein the width of each tooth of the plurality of teeth is more than three times the height of the respective tooth.

4. The power skiving tool according to claim 1, wherein a first tangent applied in said cross-section to the first end of the convexly rounded contour and a second tangent applied in said cross-section to the second end of the convexly rounded contour intersect at an angle α, where 60°≤α≤140.

5. The power skiving tool according to claim 1, wherein each of the first concave transition contour and the second concave transition contour is a radius when viewed in said cross-section.

6. The power skiving tool according to claim 1, wherein each tooth of the plurality of teeth has a shape identical to the remaining teeth of the plurality of teeth.

7. The power skiving tool according to claim 1, wherein each of the plurality of teeth comprises a rake face at an end of the cutting head that is facing away from the shank, the rake face being inclined at an angle other than 90° with respect to the longitudinal axis.

8. The power skiving tool according to claim 7, wherein the rake faces of all the teeth of the plurality of teeth are arranged in a common conical surface that is rotationally symmetrical to the longitudinal axis.

9. The power skiving tool according to claim 7, wherein between the rake faces of two adjacent teeth of the plurality of teeth there is respectively arranged a transition face, which is also arranged at the front end of the cutting head and directly adjoins the rake faces of the two adjacent teeth.

10. The power skiving tool according to claim 1, wherein each of the plurality of teeth comprises a circumferentially arranged flank oriented skew to the longitudinal axis.

11. The power skiving tool according to claim 1, wherein the plurality of teeth comprises more than twelve teeth.

12. The power skiving tool according to claim 1, wherein the shank is made of steel and the teeth of the cutting head are made of carbide.

13. A method for machining a workpiece, comprising the steps of:
providing a power skiving tool and the workpiece to be machined;
producing an outer contour on the workpiece by means of the power skiving tool during power skiving machining, wherein the outer contour to be produced corresponds to a regular convex polygon in a cross-sectional profile of the workpiece, and wherein the power skiving tool and the workpiece are rotated with opposite directions of rotation to one another during the power skiving machining, wherein an axis of rotation of the power skiving tool is aligned at a defined axis cross angle with respect to an axis of rotation of the workpiece, and wherein the power skiving tool and/or the workpiece are simultaneously moved translationally to generate a feed motion.

14. The method of claim 13, wherein the power skiving machining comprises rotating the power skiving tool at a first speed and rotating the workpiece at a second speed, wherein the second speed is an integer multiple of the first speed.

15. The method according to claim 13, wherein the power skiving tool comprises a shank that extends along a longitudinal axis of the tool, and a cutting head that is arranged at an end face of the shank, wherein the cutting head comprises a plurality of circumferentially arranged teeth, wherein, when viewed in a cross-section orthogonal to the longitudinal axis, each of the teeth comprises a convexly rounded contour, which at a first end transitions either directly or via a first concave transition contour into the convexly rounded contour of a first adjacent tooth of the plurality of teeth and at a second end opposite the first end transitions either directly or via a second concave transition contour into the convexly rounded contour of a second adjacent tooth of the plurality of teeth, and wherein a width of each tooth of the plurality of teeth, measured in the cross-section as a distance between the first end and the second end, is greater than a height of the respective tooth measured in the cross-section orthogonal to the width and centrally between the first end and the second end.
